(19) United States
(12) Patent Application Publication
(10) Pub. No.: US 2006/0084318 A1
(43) Pub. Date: Apr. 20, 2006

(54) Double-side mounting electrical connector

(76) Inventors: Jason Si, Scarborough (CA); Linlan Deng, Markham (CA)

Correspondence Address: BLANK ROME LLP, 600 NEW HAMPSHIRE AVENUE, N.W., WASHINGTON, DC, 20037, US

(21) Appl. No.: 11/250,504

(22) Filed: Oct. 17, 2005

Related U.S. Application Data
(60) Provisional application No. 60/619,003, filed on Oct. 18, 2004.

(51) Int. Cl. H01R 13/73

(52) U.S. Cl. 439/564

(57) ABSTRACT

An electrical connector that includes a housing with a connector interface disposed between first and second ends of the housing. A bottom portion of the housing has a printed circuit board engaging surface. The first end of the housing includes a first hole adapted to receive a first fastener and the second end includes a first bore adapted to receive a second fastener. A removable cover is coupled to the rear portion of the housing. The cover includes an extension extending into a rear portion of the housing. The electrical connector is mountable to a second substantially identical connector on an opposite side of a printed circuit board.

### RELATED APPLICATION INVENTION

This application claims the benefit of U.S. Provisional Patent Application Ser. No. 60/619,003, filed on Oct. 18, 2004, the subject matter of which is incorporated herein by reference in its entirety.

### FIELD OF THE INVENTION

The present invention relates to an electrical connector for a printed circuit board, and more specifically relates to an electrical connector coupled to an identical connector on an opposite side of the printed circuit board.

### BACKGROUND OF THE INVENTION

Conventional electrical connectors that mount to both sides of a printed circuit board often include mounting members, such as barbs or boardlocks, which engage openings of the circuit board to secure the electrical connector to the board. Frequently the mounting members loosen allowing the electrical connectors to separate from the board.

Additionally, conventional electrical connectors for printed circuit boards often fail to provide adequate EMI shielding. Typical shields for conventional electrical connectors commonly fail to provide complete protection, and allow leakage of EMI, thereby increasing interference with other connectors.

Examples of conventional electrical connectors include U.S. Pat. Nos. 6,652,292 to Pratt et al., U.S. Pat. No. 6,319,058 to Jones, U.S. Pat. No. 5,921,812 to Choy, U.S. Pat. No. 5,807,136 to Mick, U.S. Pat. No. 5,482,474 to Yohn et al., U.S. Pat. No. 5,254,016 to Ganthier, U.S. Pat. No. 5,080,611 to Hypes, 5,059,130 to Miller, Jr., and U.S. Pat. No. 4,173,387 to Zell, the subject matter of each of which is herein incorporated by reference.

### SUMMARY OF THE INVENTION

Accordingly, an object of the present invention is to provide an electrical connector that is mounted to a printed circuit board by securing it to an opposite identical connector.

Another object of the present invention is to provide an electrical connector for mounting on a printed circuit board that includes sufficient EMI shielding.

The foregoing objects are basically attained by an electrical connector that includes a housing with a connector interface disposed between first and second ends thereof, a rear portion opposite the connector interface, and a bottom portion having a printed circuit board engaging surface. The first end includes a first hole adapted to receive a first fastener and the second end includes a first bore adapted to receive a second fastener. A removable cover is coupled to the rear portion of the housing. The cover includes at least a first extension extending into the rear portion of the housing.

The foregoing objects are also attained by an electrical connector assembly that includes a printed circuit board with opposite first and second surfaces, and first and second openings. First and second substantially identical connectors are disposed on the first and second surfaces of the printed circuit board, respectively. Each of the first and second connectors including a housing with a connector interface disposed between first and second ends of the housing. Each of the first ends includes a first hole and each of the second ends includes a first threaded bore. A first fastener extending through the first hole of the first connector and through the first opening in the printed circuit board without engaging the printed circuit board. The first fastener has a distal end engaging the first threaded bore of the second connector. A second fastener extends through the first hole of the second connector and through the second opening in the printed circuit board without engaging the printed circuit board. The second fastener has a distal end engaging the first threaded board of said first connector. The first and second fasteners are separate and removable from the first and second connectors.

Other objects, advantages and salient features of the invention will become apparent from the following detailed description, which, taken in conjunction with the annexed drawings, discloses preferred embodiments of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a front perspective view of two electrical connectors in accordance with the present invention, showing the connectors mounted to opposite sides of a printed circuit board;

FIG. 2 is a rear perspective view of the electrical connectors illustrated in FIG. 1;

FIG. 3 is an exploded perspective view of the electrical connectors illustrated in FIG. 1;

FIG. 4 is a partial elevational view of the electrical connectors taken in section along line 4-4 of FIG. 1;

FIG. 5 is a bottom perspective view of the electrical connectors illustrated in FIG. 1;

FIG. 6 is a rear perspective view of the electrical connector illustrated in FIG. 5;

FIG. 7 is a perspective view of a cover in accordance with the present invention; and

FIG. 8 is a rear perspective view of two electrical connectors in accordance with a second embodiment of the present invention, showing the electrical connectors mounted on a printed circuit board.

### DETAILED DESCRIPTION OF THE INVENTION

Referring to FIGS. 1-8, substantially identical electrical connectors 10 and 12 are electrically connected to traces on opposite sides of a printed circuit board 14, and fastened to each other by fasteners, such as screws. By connecting the connectors 10 and 12 to both sides of the board 14, a higher density of connectors is provided because the connectors are not limited to one side of the board 14.

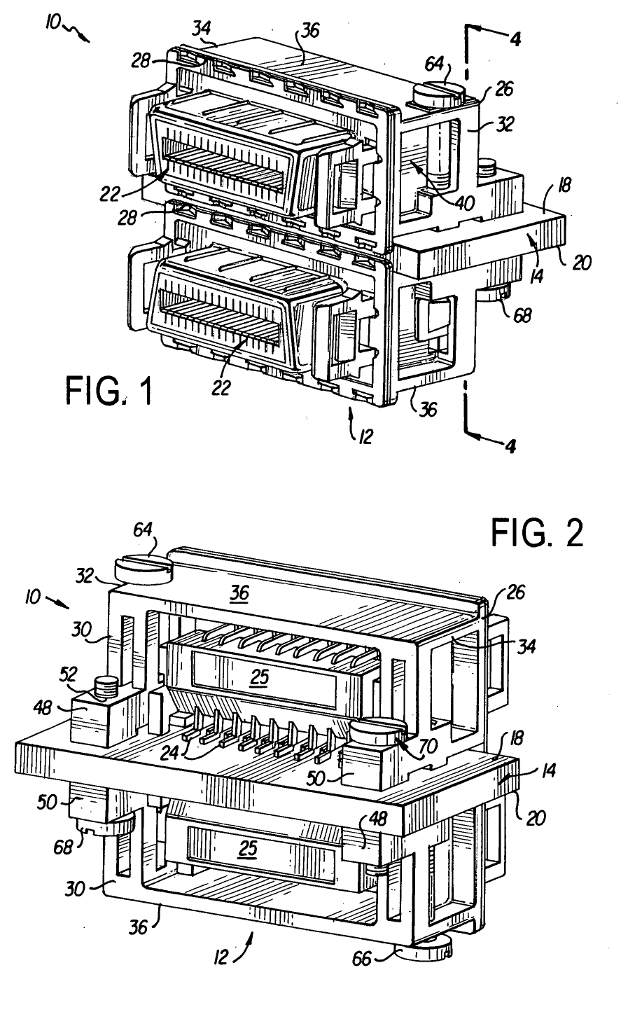

As seen in FIG. 1, the first connector 10 mounts to the first surface 18 of the board 14. The second connector is rotated 180° and mounted to the second surface 20 of the board 14 opposite the first connector 10. Although the connectors are similar to conventional connectors, such as their connector interfaces 22 (FIG. 1) and their connector leads 24 (FIG. 2), the housings or shells 26 and the mounting arrangement of each connector 10 and 12 are not conventional.

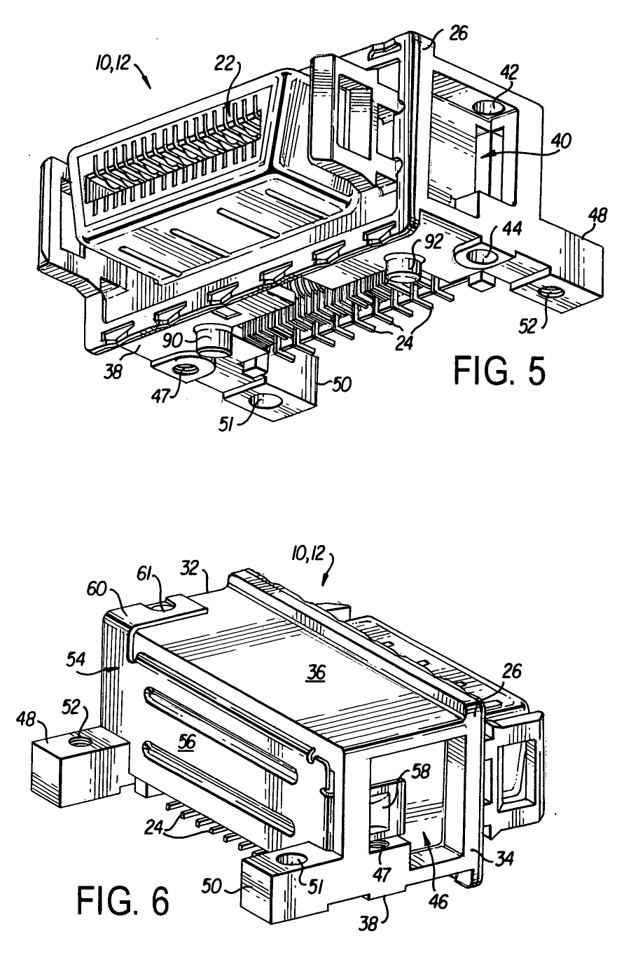

Housing 26 of each connector 10 and 12 includes a front frame 28 (FIG. 1) and an opposite rear wall 30 (FIG. 2), first and second endwalls 32 and 34, and top and bottom walls or sidewalls 36 and 38 with the leads 24 extending through the bottom wall 38. The housing 26 includes an inner area for supporting the connector body 25 and leads 24 (FIG. 2) with the front frame 28 being open to allow the connector interface 22 to extend therethrough. As seen in FIGS. 1 and 5, the first endwall 32 has a recessed area 40. A through hole 42 (FIG. 5) is disposed in the top wall 36 at the first endwall 32. A corresponding through bore 44 (FIG. 5) is disposed in the bottom wall 38. Bore 44 is vertically aligned with hole 42, as seen in FIG. 4. As seen in FIG. 6, the second endwall 34 has a recessed area 46 similar to recessed area 40 of the first endwall 34. The bottom wall 38 at the recessed area 46 includes a threaded bore 47, as seen in FIGS. 5 and 6.

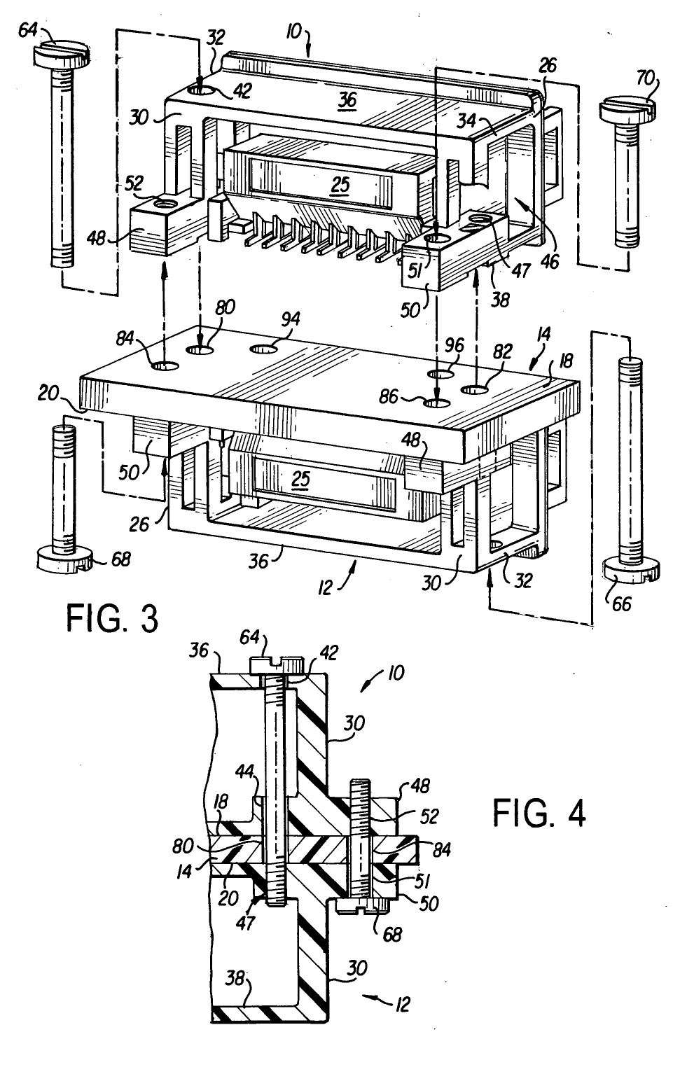

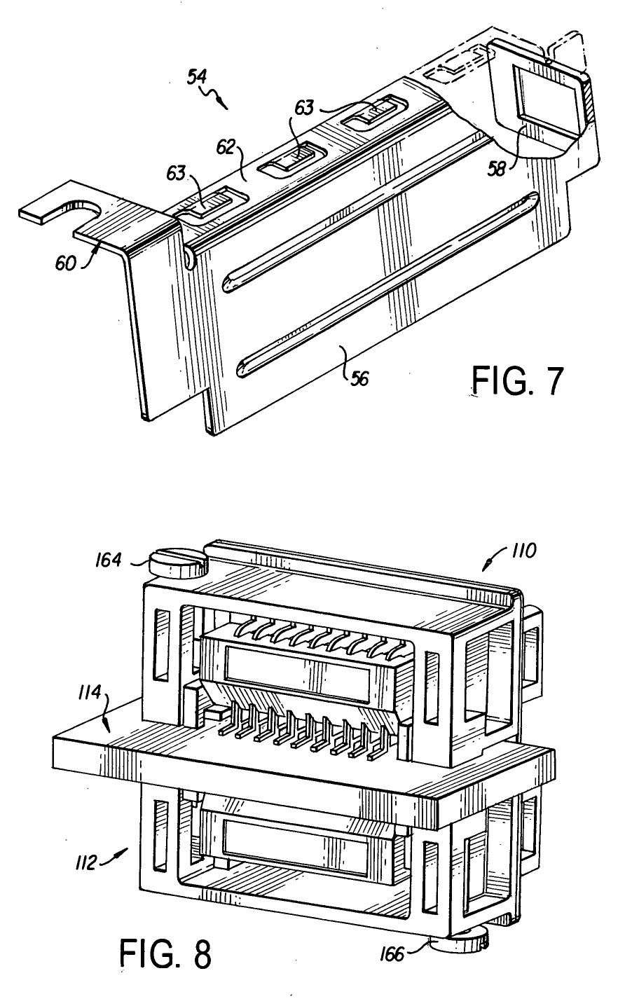

As seen in FIGS. 2 and 3, rear wall 30 of each connector 10 and 12 includes first and second outwardly extending arms 48 and 50 located at each endwall 32 and 34, respectively. Arm 48 includes a threaded bore 52 and arm 50 includes a hole 51 for receiving a fastener, such as a screw. The rear wall 30 also includes a metal (e.g. stainless steel) cover 54, as seen in FIGS. 6 and 7, that provides EMI shielding by completely closing off the back of the connector. Cover 54 includes a main plate 56 with a clip 58 extending from one end thereof that snaps into the recessed area 46 of the housing 26, as best seen in FIG. 6. An L-shaped extension 60 extending from the other end of main plate 56 rests on the top wall 36 of housing 26. Extension 60 can include a cut-out 61 corresponding to through hole 42 to avoid interference with the fastener. Cover 54 also includes a flange 62 that extends into the inner area of the housing 26. Flange 62 includes resilient fingers 63 that facilitate EMI protection by filling the gap between the connector body 25 and the inside of the housing 26 to substantially prevent EMI leakage.

The first connector 10 is mounted to the first surface 18 of the board 14 by a first fastener or screw 64 (FIG. 1) that extends through the through hole 42 and bore 44 at the first endwall 32 of the housing 26 and through a first opening 80 (FIG. 3) of the board 14. First screw 64 does not engage board 14 and instead extends through opening 80, as best seen in FIG. 4. Likewise, the second connector 12 is rotated and mounted to the second surface 20 of the board 14 by a second screw 66 (FIG. 2) by extending the second screw 66 through the hole 42 and the bore 44 of the second connector 12 and into a second opening 82 (FIG. 3) in the board 14. The first screw 64 threads into the bore 47 (FIG. 6) at the second endwall 32 of the second connector 12, as seen in FIG. 4, and the second screw 66 threads into the bore 47 of the first connector 10 in a similar manner, thereby connecting the first and second connectors 10 and 12 to each other without engaging the board 14. The first and second screws 64 and 66 also secure the L-shaped extensions 60 of the covers 54 to the housings 26 of each connector.

The leads 24 of each connector 10 and 12 connect to traces on surfaces 18 and 20 of the board 14 in a conventional manner. Alignment posts 90 and 92 (FIG. 5) can be provided extending from bottom wall 38 of each connector 10 and 12 to locate the connectors 10 and 12 on the board 14. First and second post apertures 94 and 96 (FIG. 3) are provided in the board 14 to receive the alignment posts 90 and 92. The alignment posts 90 and 92 of the connectors 10 and 12 share post apertures 94 and 96. Alignment posts 90 and 92 of the first connector 10 are received in first and second post apertures 94 and 96, respectively. For the second connector 12, the alignment post 90 is received in the second post aperture 96 and the alignment post 92 is received in the first post aperture 94. Thus, post 90 of first connector 10 and post 92 of second connector 12 share first post aperture 94 of board 14 and post 92 of first connector 10 and post 90 of second connector 12 share second post aperture 96 of board 14.

To further secure the first and second connectors 10 and 12, with the board 14 in between, a third screw 68 (FIG. 2) extends through the hole 51 of arm 50 of the second connector 12, through a third opening 84 (FIG. 3) of the board 14, and threaded into threaded bore 52 of arm 48 of the first connector 10, as seen in FIG. 4. Similarly, a fourth screw 70 (FIG. 2) extends through the hole 51 of arm 50 of the first connector 10, through a fourth opening 86 (FIG. 3), and threaded into threaded bore 52 of arm 48 of the second connector 12. Like first and second screws 64 and 66, third and fourth screws 68 and 70 do not engage the board 14 and instead engage the opposite connector. Also, screws 64, 66, 68 and 70 are easily removed from connectors 10 and 12 without having to remove the connectors 10 and 12 from the board 14. The design of each connector 10 and 12 allows the two connectors to be secured to each other with the board 14 sandwiched in between. Because the connectors 10 and 12 are identical, manufacturing and assembly costs are reduced.

Referring the FIG. 8, a second embodiment of the present invention includes connectors 110 and 112 which are the same as connectors 10 and 12 of the first embodiment, except that rear arms 48 and 50 have been removed. Thus, only first and second screws 164 and 166 are used to secure the connectors 110 and 112 to each other in the same manner as screws 64 and 66 of the first embodiment with the board 114 in between.

While particular embodiments have been chosen to illustrate the invention, it will be understood by those skilled in the art that various changes and modifications can be made therein without departing from the scope of the invention as defined in the appended claims.

What is claimed is:

1. An electrical connector, comprising:
a housing with a connector interface disposed between first and second ends of said housing, a rear portion opposite said connector interface, and a bottom portion having a printed circuit board engaging surface, said first end includes a first hole adapted to receive a first fastener and said second end includes a first bore adapted to receive a second fastener; and
a removable cover coupled to said rear portion of said housing, said cover including at least a first extension extending into said rear portion of said housing.

2. An electrical connector according to claim 1, wherein
said first extension is a longitudinal flange extending between two opposite ends of said cover; and
said flange including a plurality of resilient tabs for frictionally engaging said housing.

3. An electrical connector according to claim 1, wherein
said cover includes a second extension extending from an end of said cover; and
said second extension including a resilient clip for a snap fitting engagement with said housing.

4. An electrical connector according to claim 1, wherein
said cover includes a second extension extending from an end of said cover; and
said second extension engaging said housing and including a cut-out axially aligned with said first hole for receiving said first connector.

5. An electrical connector according to claim 4, wherein
said cover includes a third extension extending from an opposite end of said cover; and
said third extension includes a resilient clip for snap fitting engagement with said housing.

6. An electrical connector according to claim 1, wherein
said cover covers an opening in said rear portion of said housing.

7. An electrical connector according to claim 1, wherein
said housing includes first and second arms extending from said rear portion;
said first arm includes a second bore adapted to receive a third connector; and
said second arm includes a second hole adapted to receive a fourth connector.

8. An electrical connector according to claim 1, wherein
said bottom portion of said housing includes at least one aligmnent post extending therefrom.

9. An electrical connector assembly, comprising:
a printed circuit board with opposite first and second surfaces, and first and second openings;
first and second substantially identical connectors disposed on said first and second surfaces of said printed circuit board, respectively, each of said first and second connectors including a housing with a connector interface disposed between first and second ends of said housing, each of said first ends includes a first hole and each of said second ends includes a first threaded bore;
a first fastener extending through said first hole of said first connector and through said first opening in said printed circuit board without engaging said printed circuit board, and said first fastener having a distal end engaging said first threaded bore of said second connector; and
a second fastener extending through said first hole of said second connector and through said second opening in said printed circuit board without engaging said printed circuit board, and said second fastener having a distal end engaging said first threaded board of said first connector, and
said first and second fasteners being separate and removable from said first and second connectors.

10. An electrical connector assembly according to claim 9, further comprising
first and second covers coupled to a rear portion opposite said connector interface.

11. An electrical connector assembly according to claim 10, wherein
each of said first and second covers includes a first extension that is a longitudinal flange extending between two opposite ends of said respective first and second cover; and
each of said flanges including a plurality of resilient tabs for frictionally engaging said housing.

12. An electrical connector assembly according to claim 11, wherein
each of said first and second covers includes second and third extensions;
each of said second extensions extending from an end of said respective first and second cover and including a resilient clip for a snap fitting engagement with said housing; and
said third extension engaging said housing and including a cut-out axially aligned with said first hole of said respective first and second connector for receiving said respective first and second connector.

13. An electrical connector assembly according to claim 9, further comprising
first and second arms extending from housing of each of said first and second connectors;
each of said first arms includes a second threaded bore; and
each of said second arms includes a second hole.

14. An electrical connector assembly according to claim 13, further comprising
a third fastener extending through said second hole of said second connector, through a third opening in said printed circuit board without engaging said printed circuit board, said third connector having a distal end threadably engaging said second threaded bore of said first connector, and said third fastener being separate and removable from said first and second connectors.

15. An electrical connector assembly according to claim 14, further comprising
a fourth fastener extending through said second hole of said first connector, through a fourth opening in said printed circuit board without engaging said printed circuit board, said fourth fastener including a distal end threadably engaging said second threaded bore of said second connector.

16. An electrical connector assembly according to claim 9, wherein
said housing of each of said first and second connectors includes a bottom portion extending between said first and second ends, said bottom portion of each of said first and second connectors including first and second alignment posts.

17. An electrical connector assembly according to claim 16, wherein
said first alignment posts of each of said first and second connectors are received in a first post aperture of said printed circuit board; and
said second alignment posts of each of said first and second connectors are received in a second post aperture of said printed circuit board.
